(19) United States
(12) Patent Application Publication
(10) Pub. No.: US 2026/0188307 A1
(43) Pub. Date: Jul. 2, 2026

(54) EXPLAINABLE ATTENTION DECISIONS IN MULTI-SOURCE ENVIRONMENTS

(71) Applicant: Attention Labs Incorporated, Newark, DE (US)

(72) Inventors: Bonny Banerjee, Collierville, TN (US); Daniyal Anjum, Milton (CA); Omar Abbasi, Guelph (CA); David J. Kim, Toronto (CA)

(21) Appl. No.: 19/416,162

(22) Filed: Dec. 11, 2025

Related U.S. Application Data
(63) Continuation-in-part of application No. 19/386,258, filed on Nov. 12, 2025.
Application No. 19/386,258 is a continuation of application No. 19/386,190, filed on Nov. 11, 2025.
Application No. 19/386,190 is a continuation of application No. 19/357,513, filed on Oct. 14, 2025.
Application No. 19/357,513 is a continuation-in-part of application No. 19/298,180, filed on Aug. 13, 2025.
Application No. 19/298,180 is a continuation of application No. 19/296,932, filed on Aug. 12, 2025.
Application No. 19/296,932 is a continuation of application No. 19/241,399, filed on Jun. 18, 2025.
Application No. 19/241,399 is a continuation of application No. 19/236,996, filed on Jun. 13, 2025.
Application No. 19/236,996 is a continuation of application No. 19/221,496, filed on May 28, 2025.
Application No. 19/221,496 is a continuation of application No. PCT/US25/29916, filed on May 18, 2025.
Application No. PCT/US25/29916 is a continuation-in-part of application No. 19/093,220, filed on Mar. 27, 2025.
Application No. 19/093,220 is a continuation of application No. 19/069,128, filed on Mar. 3, 2025.
(60) Provisional application No. 63/739,560, filed on Dec. 28, 2024.
(60) Provisional application No. 63/741,998, filed on Jan. 6, 2025.

(51) Int. Cl. G10L 15/02; G10L 15/16

(52) U.S. Cl. CPC G10L 15/02; G10L 15/16

(57) ABSTRACT

Systems, methods and computer-readable media for providing explainable selective attention in multi-source or multi-speaker environments. A selective attention module receives multimodal sensor data including audio, video, gaze, text, and physiological signals from a plurality of sources. An attention inference engine generates attention distributions over the sources and fuses them into a probabilistic belief state. An explainability module produces interpretable outputs corresponding to the fused belief, including attention matrices, confidence scores, reliability measures, margin-based differentiators, and natural language rationales. The explainability outputs are rendered through visual, auditory, or augmented/virtual reality interfaces to indicate the attended source, suppressed sources, and reasoning for the selection. The system enables user interaction by providing justifications in real time, logging explanations for retrospective analysis, and supporting adaptation of thresholds and model weights based on feedback. The disclosed technology improves transparency, interpretability, and trust in selective attention systems, while maintaining real-time performance in dynamic multi-speaker environments.

### REFERENCE TO RELATED APPLICATIONS

This application claims the benefit of (i) U.S. Provisional Application No. 63/739,560 entitled ATTENTION MODELING IN MULTI-SPEAKER ENVIRONMENTS and filed on Dec. 28, 2024 by inventors David J. Kim, Omar Abbasi and Daniyal Anjum, of (ii) U.S. Provisional Application No. 63/741,998 entitled ATTENTION MODELING IN MULTI-SPEAKER ENVIRONMENTS and filed on Jan. 6, 2025 by inventors David J. Kim, Omar Abbasi and Daniyal Anjum, of (iii) U.S. patent application Ser. No. 19/069,028 entitled ATTENTION MODELING IN MULTI-SPEAKER ENVIRONMENTS and filed on Mar. 3, 2025 by inventors David J. Kim, Omar Abbasi and Daniyal Anjum, of (iv) U.S. patent application Ser. No. 19/093,220 entitled SELECTIVE AUDITORY ATTENTION IN MULTI-PARTICIPANT ENVIRONMENTS and filed on Mar. 27, 2025 by inventors David J. Kim, Omar Abbasi and Daniyal Anjum, of (v) U.S. patent application Ser. No. 19/221,496 entitled SELECTIVE AUDITORY ATTENTION IN MULTI-PARTICIPANT ENVIRONMENTS and filed on May 28, 2025 by inventors David J. Kim, Omar Abbasi, Daniyal Anjum and Bonny Banerjee, of (vi) U.S. patent application Ser. No. 19/236,996 entitled DYNAMIC CONVERSATION GRAPH GENERATION and filed on Jun. 13, 2025 by inventors David J. Kim, Omar Abbasi, Daniyal Anjum and Bonny Banerjee, of (vii) U.S. patent application Ser. No. 19/241,399 entitled DISTRIBUTED PROCESSING ARCHITECTURE FOR ATTENTION MODELING and filed on Jun. 18, 2025 by inventors David J. Kim, Omar Abbasi, Daniyal Anjum and Bonny Banerjee, of (viii) U.S. patent application Ser. No. 19/296,932 entitled MULTI-PARTICIPANT CONVERSATION STATE DETECTION and filed on Aug. 12, 2025 by inventors David J. Kim, Omar Abbasi, Daniyal Anjum and Bonny Banerjee, of (ix) U.S. patent application Ser. No. 19/298,180 entitled MULTI-PARTICIPANT VOICE ACTIVITY DETECTION and filed on Aug. 13, 2025 by inventors David J. Kim, Omar Abbasi, Daniyal Anjum and Bonny Banerjee, of (x) U.S. patent application Ser. No. 19/357,513 entitled CONTEXT-AWARE DYNAMIC ATTENTION WITH CONVERSATIONAL GRAPHS AND UTILITY SCHEDULING and filed on Oct. 14, 2025 by inventors Bonny Banerjee, David J. Kim, Omar Abbasi and Daniyal Anjum, of (xi) U.S. patent application Ser. No. 19/360,913 entitled SPATIAL AUDIO PROCESSING WITH MOTION-COMPENSATED BEAMFORMING and filed on Oct. 16, 2025 by inventors David J. Kim, Omar Abbasi, Daniyal Anjum and Bonny Banerjee, of (xii) U.S. patent application Ser. No. 19/369,612 entitled SYSTEMS AND METHODS FOR DYNAMIC REAL-TIME GROUPING OF MULTILINGUAL MULTI-SPEAKER TEXT STREAMS BY CONVERSATION TOPICS and filed on Oct. 27, 2025 by inventors Sina Gholamian, Bonny Banerjee, Daniyal Anjum, Omar Abbasi and David J. Kim, of (xiii) U.S. patent application Ser. No. 19/386,190 entitled UNIFIED SYSTEM FOR SELECTIVE ATTENTION IN MULTI-SOURCE ENVIRONMENTS and filed on Nov. 11, 2025 by inventors Bonny Banerjee, Daniyal Anjum, Omar Abbasi and David J. Kim, of (xiv) U.S. patent application Ser. No. 19/386,258 entitled UNIFIED SYSTEM FOR SELECTIVE ATTENTION IN MULTI-SOURCE ENVIRONMENTS and filed on Nov. 12, 2025 by inventors Bonny Banerjee, Daniyal Anjum, Omar Abbasi and David J. Kim, of (xv) U.S. patent application Ser. No. 19/387,549 entitled MULTI-STREAM SOURCE SEPARATION WITH CROSS-MODAL ENHANCEMENT and filed on Nov. 12, 2025 by inventors David J. Kim, Omar Abbasi, Daniyal Anjum and Bonny Banerjee, of (xvi) U.S. patent application Ser. No. 19/387,630 entitled MULTI-DEVICE AUDIO-BASED SPATIAL TRACKING and filed on Nov. 13, 2025 by inventors David J. Kim, Omar Abbasi, Daniyal Anjum and Bonny Banerjee, of (xvii) U.S. patent application Ser. No. 19/387,944 entitled GAZED-BASED ATTENTION and filed on Nov. 13, 2025 by inventors David J. Kim, Omar Abbasi, Daniyal Anjum and Bonny Banerjee, and of (xviii) PCT Application No. PCT/US25/29916 entitled SELECTIVE AUDITORY ATTENTION IN MULTI-PARTICIPANT ENVIRONMENTS and filed on May 18, 2025 by inventors David J. Kim, Omar Abbasi, Daniyal Anjum and Bonny Banerjee, the contents all of which are incorporated herein by reference in their entireties.

### FIELD OF THE INVENTION

The present invention relates to systems and methods for selective attention in multi-source or multi-speaker environments, and more particularly to generating interpretable explanations for attention routing decisions made by multimodal selective attention systems.

### BACKGROUND OF THE INVENTION

Selective attention systems for multi-speaker and multi-sensor environments aim to determine which source of information (e.g., a particular speaker, background music, or environmental cue) should be prioritized at a given time while suppressing other sources. Current methods often rely on complex probabilistic fusion, neural networks, and dynamic attention graphs.

However, such systems generally operate as “black boxes,” offering little to no explanation for why an attention decision was made. Lack of transparency limits user trust, hinders debugging, and complicates regulatory acceptance in sensitive domains such as healthcare, defense, and enterprise collaboration.

Therefore, there is a need for systems and methods that provide explainability in selective attention, enabling interpretable, human-understandable rationales for system decisions without compromising efficiency or accuracy.

Why this is Important
Transparency: Users, regulators, and enterprises can understand why the system picked a certain source.
Trust: Increases adoption by showing reasoning, not just outcomes.
Debugging & Optimization: Engineers can inspect explanations to refine models.
Compliance: Future AI systems may require mandatory explainability.

### SUMMARY

The disclosed invention provides systems, methods, and apparatus for explainable selective attention in multi-source environments. The system generates interpretable rationales for selective attention routing by:
1. Constructing attention matrices from multimodal probabilistic estimators.
2. Computing explanation features (e.g., conversational importance scores, confidence thresholds, reliability weights).
3. Producing human-readable justifications through structured explanations (e.g., scores, graphs, heatmaps) and/or natural language rationales.

These explanations may be presented to the user directly (e.g., in augmented reality/virtual reality overlays, captions, or dashboards) or logged for auditing and compliance purposes.

There is thus provided in accordance with an embodiment of the present invention a system for explainable selective attention in multi-source environments, including a plurality of probabilistic attention estimators, each generating a distribution over a set of sources and an associated confidence score, a fuser combining the distributions into a fused belief distribution; an explainer deriving explanation features comprising at least one of: attention weights, reliability scores, utility scores, and decision threshold margins, and an interpreter generating structured outputs or natural language rationales based on the explanation features.

Additionally, the structured outputs include visual heatmaps highlighting relative attention weights across sources.

Further, the structured outputs include conversation graphs with nodes representing sources and edges weighted by attention strength.

Yet further, the interpreter generates natural language justifications, including at least one sentence explaining why a source was attended to.

Moreover, the reliability scores are updated dynamically based on at least one of historical accuracy, latency performance, and consistency across modalities.

Additionally, the utility scores are computed as a function of contextual relevance and user preferences.

Further, the interpreter renders rationales in augmented reality or virtual reality environments, including overlays aligned with attended sources.

Yet further, the explainer produces confidence margins by computing differences between decision thresholds and fused probabilities.

Moreover, the explanations are logged for auditing, regulatory compliance, or post-hoc analysis.

Additionally, the explanation features further comprise cross-modal alignment scores indicating consistency between modalities such as audio, video, and physiological signals.

There is further provided in accordance with an embodiment of the present invention a method of explainable selective attention, including receiving multimodal signals from a plurality of sources, generating source-specific probability distributions and confidence scores using probabilistic attention estimators, fusing the probability distributions into a fused belief distribution, computing explanation features including at least attention weights, reliability scores, or decision margins, and generating interpretable rationales in structured or natural language form.

Yet further, the method includes rendering a visual heatmap of attended sources.

Moreover, the method includes generating a conversation graph representing attention dynamics among multiple speakers.

Additionally, the interpretable rationales are expressed as natural language statements generated from explanation features.

Further, the method includes dynamically updating trust or reliability scores for each source.

Yet further, the structured rationale is presented in real-time within an augmented reality/virtual reality interface.

Moreover, the method includes logging the explanation features and rationales to a knowledge base for retrospective analysis.

Additionally, explanation features further include user-specific utility values that adjust importance of certain sources.

There is further provided in accordance with an embodiment of the present invention a non-transitory computer-readable medium storing instructions that, when executed by a processor, cause the processor to perform a method including receiving multimodal inputs from a plurality of sources, computing probabilistic attention distributions and confidence scores, fusing the distributions into a fused belief distribution, computing explanation features including attention weights, reliability scores, or threshold margins, and outputting structured or natural language rationales for the selective attention decision.

Yet further, the structured rationale comprises visual attention overlays.

Moreover, the natural language rationale includes explanations of source prioritization expressed in a shared vocabulary.

Additionally, the instructions cause the processor to log explanations and features for compliance in regulated environments.

Further, the instructions cause the processor to generate conversation graphs with weighted edges representing inter-speaker relationships.

Yet further, the instructions cause the processor to compute explanation features including cross-modal consistency metrics between modalities.

### BRIEF DESCRIPTION OF THE DRAWINGS

The present invention will be more fully understood and appreciated from the following detailed description, taken in conjunction with the drawings in which:

FIG. 1 is a simplified architectural block diagram of a system for explainable selective attention, in accordance with an embodiment of the present invention;

FIG. 2 is a simplified flowchart of a process for explainable selective attention, in accordance with an embodiment of the present invention;

FIG. 3 is a simplified flowchart of a process for explainable selective attention, in accordance with an embodiment of the present invention; and

FIG. 4 is an exemplary attention heatmap, in accordance with an embodiment of the present invention, in accordance with an embodiment of the present invention.

The APPENDIX provides a complete, implementable recipe for explainable selective attention, in accordance with an embodiment of the present invention.

### DETAILED DESCRIPTION

### Notation

The following notation is used throughout the description hereinbelow.

Let there be a set of sources S={s_1, s_2, . . . , s_M}.

N: number of probabilistic attention estimators (models).

Each probabilistic attention estimator iϵ{1, 2, . . . , N} outputs:
a probability distribution P_i(s), where P_i(s)ϵ[0,1] and Σ_{sϵS} P_i(s)=1, and
a confidence score c_iϵ[0,1].

The fused belief distribution is denoted as:

$$P \hat{} \{ fused \} ( s ) = Σ\_ \{ i = 1 \} \hat{} N w\_i P\_i ( s ) ,$$

where w_i=c_i/Σ_{j=1}\hat{ }N c_j is a normalized weight based on estimator confidence.
a_s: normalized attention weight for source s (explainability feature).
r_s(t)ϵ[0,1]: reliability score for source s at time t.
u_s: utility score for source s (contextual importance).
δ_s: decision margin=P\hat{ }{fused}(s)−θ_{dec}.
κ_s: cross-modal consistency score for source s.
θ_{dec}: decision threshold (scalar).
n: learning rate for reliability updates.
\hat{s}(t): chosen attended source at time t.
s*(t): ground-truth attended source at time t (if available for supervision).

The present disclosure relates to systems, methods, and computer-readable media for providing explainable selective attention (SA) in multi-source or multi-speaker environments. The system generates attention outputs using a plurality of probabilistic estimators, fuses these outputs into a fused belief distribution, and then produces interpretable rationales to explain the decision to attend to a specific source.

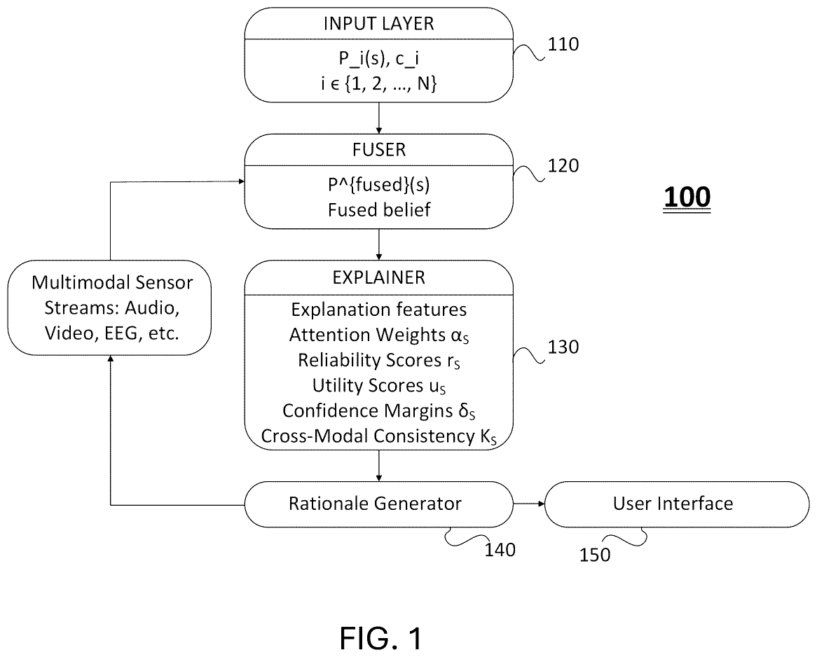

Reference is made to FIG. 1, which is a simplified architectural block diagram of a system 100 for explainable selective attention, in accordance with an embodiment of the present invention. An input layer 110 includes multimodal sensor streams (e.g., audio, video, EEG) and probabilistic estimators; namely, multiple SA models P_i(s), c_i. A fuser 120 computes fused belief P\hat{ }{fused}(s). An explainer 130 generates explanation features (a_s, r_s, u_s, δ_s, κ_s). A rationale generator 140 outputs visual and natural language rationales. A user interface 150 includes augmented reality overlays, captions, structured reports.

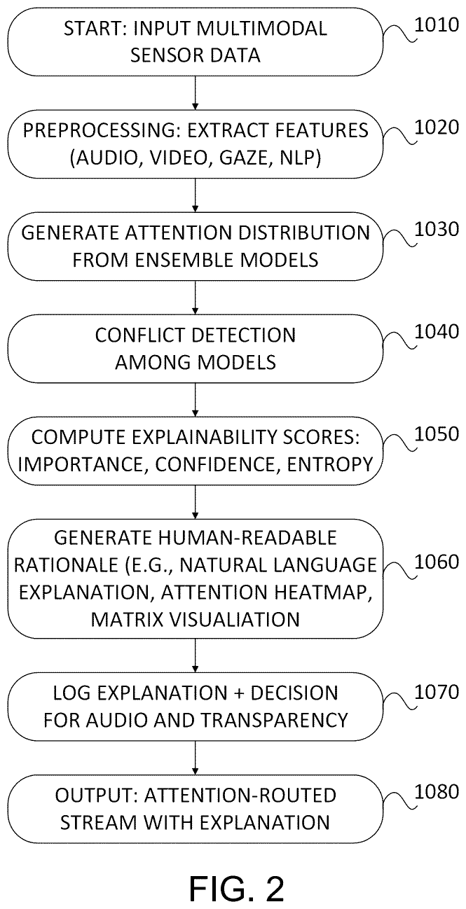

Reference is made to FIG. 2, which is a simplified flowchart of a process for explainable selective attention, in accordance with an embodiment of the present invention. FIG. 2 shows how system 100 processes multiple attention estimators, resolves conflicts, and produces both an actionable attention decision and a human-interpretable explanation.

Operation 1010—input: multiple attention estimators. The process begins with multiple probabilistic attention estimators (e.g., audio, video, NLP, multimodal). Each estimator outputs a distribution over possible attended sources and a confidence score. This operation represents the ensemble of heterogeneous models.

Operations 1030 and 1040—fusion and conflict detection. The outputs from the estimators are fused into a combined belief distribution. The process checks for conflicts, e.g., when two estimators strongly disagree. Conflict triggers the need for explanation and potentially additional external sampling.

Operation 1050—context and profile integrations. The fused belief is refined by incorporating source profiles (history, familiarity, emotional tone) and contextual cues (linguistic patterns, environmental conditions). This ensures attention is not only based on raw signals but also on learned semantics and context.

Operation 1060—decision: attended source. After fusion and context integration, the process decides on the attended source (the one the user should hear or focus on). This is the actionable part; e.g., the headphones pass through only that source's audio.

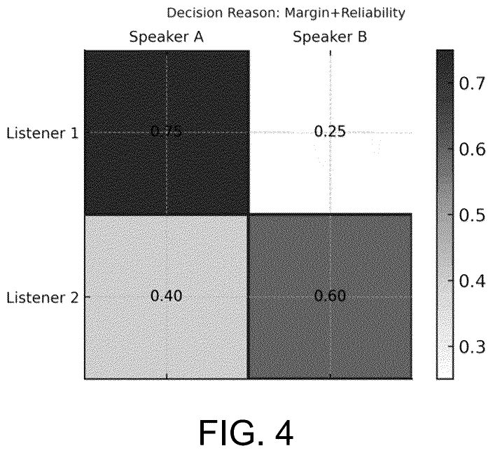

Operation 1070—explanation generator. Parallel to decision-making, the process constructs an explanation layer.
Natural language explanation: e.g., “You are listening to Speaker B because their speech matched your recent conversation topic.”
Attention matrix visualization: Graphical view of who is attending to whom (see FIG. 4).
Conversational importance scores: Numeric or ranked measures of why the system favored one source.

Operation 1080—output. The process produces two synchronized outputs.
Operational output: The attended audio/video stream for the user.
Explainability output: A human- and machine-readable rationale (visualization, scores, natural language).

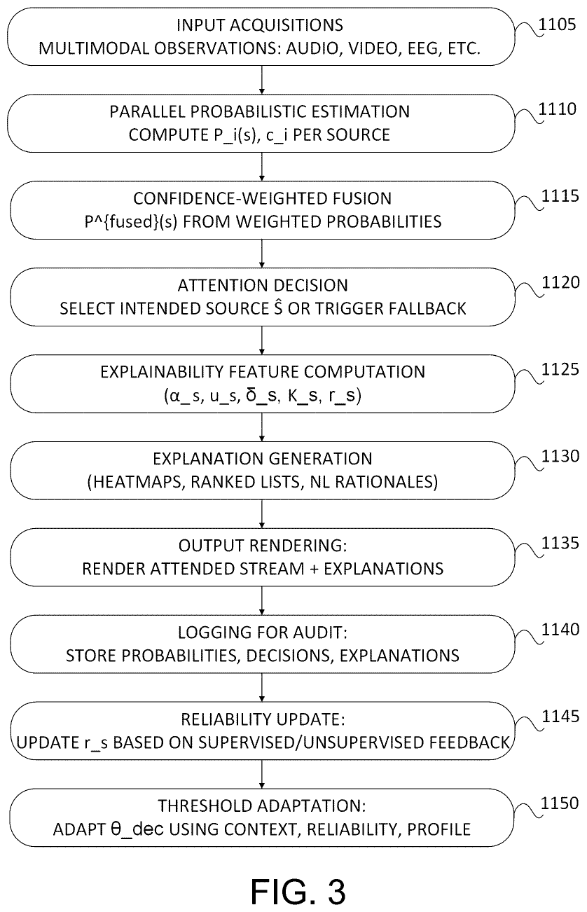

Reference is made to FIG. 3, which is a simplified flowchart of a process for explainable selective attention, in accordance with an embodiment of the present invention. FIG. 3 is a flowchart illustrating an embodiment of an explainable selective attention method. The method may be performed continuously in real time and includes the following operations.

Operation 1105—input acquisition. Multimodal observations are acquired, including but not limited to audio signals, video frames, gaze tracking, physiological signals (e.g., EEG), and contextual metadata.

Operation 1110—parallel probabilistic estimation. A plurality of probabilistic attention estimators are executed in parallel. Each estimator outputs a probability distribution P_i(s) over candidate sources S={s_1, . . . , s_M}together with a confidence value c_i.

Operation 1115—confidence weighted fusion. The estimator outputs are fused into a unified distribution according to:

$$w\_i = c\_i / Σ\_j c\_j + ε , P \hat{} \{ fused \} = Σ\_i w\_i P\_i ( s )$$

thereby producing a calibrated fused probability distribution over sources.

Operation 1120—attention decision. The method selects an attended source \hat{s} as the argmax of P\hat{ }{fused}(s). If the fused probability fails to exceed a decision threshold θ_{dec}, a conflict-resolution or fallback mechanism is triggered.

Operation 1125—explainability feature computation. For each candidate source, the method computes structured features:
Normalized attention weight: a_s=P\hat{ }{fused}(s)/max_{s′}P\hat{ }{fused}(s′)}.
Utility score: u_s=f(semantic relevance, speaker role, user preference, temporal recency).
Decision margin: β_s=P\hat{ }{fused}(s)−θ_{dec}.
Cross-modal consistency: κ_s=(1/K) Σ_{m=1}\hat{ }K I(\hat{s}_m=s)
Reliability score: r_s, maintained and updated over time.

Operation 1130—explanation generation. Based on the computed features, the method produces (a) structured explanations including heatmaps, ranked lists, and graph-based visualizations, and (b) natural-language rationales rendered from templates, e.g., “Attending to Speaker B (prob=0.74) because high reliability and strong cross-modal agreement.”

Operation 1135—output rendering. The selected attended stream is rendered to the user. Explanations are simultaneously displayed through visual overlays (e.g., AR/VR highlights and captions) or textual/audio channels.

Operation 1140—logging for audio. The method stores the fused probabilities, decisions, and generated explanations in a log for later auditing, retraining, or compliance review.

Operation 1145—reliability update. Reliability scores r_s are updated. If ground truth s* is available, supervised update is performed:

$$r\_s ( t + 1 ) = ( 1 - η ) \cdot r\_s ( t ) + η \cdot I ( \backslash hat \{ s \} ( t ) = {s}^{*} ( t ) )$$

Otherwise, unsupervised updates are computed from estimator agreement or confidence consistency.

Operation 1150—threshold adaptation. The decision threshold θ_{dec} may be adaptively adjusted based on context, such as ambient noise level, average reliability, or user profile.

Reference is made to FIG. 4, which is an exemplary attention heatmap, in accordance with an embodiment of the present invention. A matrix (Attention Matrix \hat{A}_t) showing probabilities of each listener attending to each speaker. Overlay highlights fused decision source and reasons (e.g., margin+reliability).

### Explanation Features

The explainability module computes a set of explanation features:

Attention Weights (a_s)

Defined as the normalized fused probability for each source:

$$a\_s = P \hat{} \{ fused \} ( s ) / max\_ \{ {s}^{′} ∈ S \} P \hat{} \{ fused \} ( {s}^{′} ) .$$

Indicates the relative prominence of source s.

Reliability Scores (r_s)

Each source is assigned a dynamic reliability score reflecting historical accuracy:

$$r\_s ( t + 1 ) = ( 1 - η ) \cdot r\_s ( t ) + η \cdot I ( \backslash hat \{ s \} ( t ) = {s}^{*} ) ,$$

where:
η is a learning rate,
\hat{s}(t) is the system's attended source at time t,
s* is the ground-truth attended source,
I(⋅) is an indicator function (I(a=b)=1 if a=b; else I(a=b)=0).
   Utility Scores (u_s)

The contextual importance of a suppressed source s:
u_s=f(semantic relevance, speaker role, user preference, temporal recency),
where f(⋅) is a learned utility function.

### Decision Threshold Margins (δ_s)

Defined as the gap between the fused probability and the decision threshold:

$$δ\_s = P \hat{} \{ fused \} ( s ) - θ\_ \{ d e c \} .$$

Provides a measure of confidence margin for selecting or rejecting source s.

### Cross-Modal Consistency Scores (κ_s)

Quantify agreement across modalities (e.g., audio, video, EEG):

$$κ\_s = ( 1 / K ) Σ\_ \{ m = 1 \} \hat{} K I ( ∖ hat \{ s \} \_m = ∖ hat \{ s \} ) ,$$

where \hat{s}_m is the predicted attended source from modality m.

### Rationales

Rationales may be presented as:

Structured outputs: visual heatmaps, conversation graphs, or overlays in AR/VR.

Natural language outputs: automatically generated sentences such as “Attention shifted to Speaker A because their probability exceeded the decision threshold by 20%, and reliability score increased following consistent alignment with the user's gaze.”

### Use Cases

Regulatory compliance: Logging explanations for auditing decisions in medical, defense, or enterprise applications.

User trust: Increasing transparency in consumer wearables.

Adaptive interfaces: Providing real-time rationales in AR/VR to guide user interactions.

### EXEMPLARY EMBODIMENTS

The system operates within a multi-source selective attention framework as defined in the unified attention system. At each decision step, the system computes a fused belief distribution over sources:

$$P \hat{} \{ fused \} ( s ) = F ( \{ P\_i ( s ) , c\_i \} \_ \{ i = 1 \} \hat{} K , Δ )$$

where:
P_i(s): probabilistic attention estimator from source i.
c_i: confidence score associated with P_i(s).
Δ: external evidence correction term.
F: fusion operator (ensemble, MLP, or attention-based fusion).

The explainability module augments this process by:

### Capturing Attention Weights:

Extracting attention weights a_s for each source s.

### Computing Explanation Features:

Reliability r_sϵ[0,1] of each source.

Utility score u_s for contextual relevance.

Threshold margin θ_{dec}−P\hat{ }{fused}(s).

### Generating Interpretations:

Structured outputs: attention heatmaps, ranked importance scores.

Natural language rationales: “The system focused on Speaker A because reliability r_A was high and confidence exceeded decision threshold.”

### Appendix

Below is a self-contained, implementation-oriented pseudocode, including the mathematical equations used hereinabove, in accordance with an embodiment of the present invention. This pseudocode and equations provide a complete, implementable recipe for explainable selective attention, capturing the mathematical definitions (w_i, P\hat{ }{fused}, a_s, r_s, u_s, δ_s, κ_s) and the operational loop for producing both attention routing and human-interpretable explanations.

Main Pseudocode: Explainable Selective Attention (real-time loop)

```
Initialize:
  for each source s in S:
    r_s ← r_s_initial # initial reliability (e.g., 0.5)
  θ_dec ← user_or_system_threshold
  η ← reliability_learning_rate
  Initialize any NL-rationale templates and visualization
parameters
  Initialize logging data structure LOG = [ ]
Loop: for each time step t (real-time):
  # 1) Acquire multimodal observations (e.g.,audio, video,
gaze, EEG, text)
  observations = acquire_multimodal_inputs( )
  # 2) Run N probabilistic attention estimators in parallel
  for i = 1..N:
    P_i(·), c_i = attention_estimator_i(observations)
    # P_i: mapping from S → [0,1]; sum_s P_i(s) = 1
  # 3) Fuse estimator outputs into P\hat{ }{fused}
  P_fused = FUSE({P_i}_{i=1..N}, {c_i}_{i=1...N})
    # see subroutine definition below
  # 4) Decision: choose attended source (s) using threshold
θ_dec
  s_hat = argmax_s P_fused(s)
  if P_fused(s_hat) < θ_dec:
    # undecided: optionally trigger conflict resolution or
external sampling
    trigger_conflict_resolution( )
    # for explainability still compute features below
  end if
  # 5) Compute explainability features for each source
  for each s in S:
```

| | |
|---|---|
| α_s = compute_attention_weight(P_fused, s) | # eqn (A) |
| u_s = compute_utility(s, observations) | # learned |

function, eqn (B) placeholder

| | |
|---|---|
| δ_s = P_fused(s) − θ_dec | # |

```
decision margin
    κ_s = compute_cross_modal_consistency(s, observations)
# eqn (C)
    # r_s is already maintained and updated below
  # 6) Generate explanation artifacts
  explanation_struct = build_structured_explanation(S,
P_fused, {α_s}, {r_s}, {u_s}, {δ_s}, {κ_s})
    # includes heatmap data, conversation-graph fragment,
numeric scores
  nl_rationale = generate_nl_rationale(s_hat, P_fused(s_hat),
r_s_hat = r_s, δ_s_hat = δ_s, κ_s_hat = κ_s)
    # see NL subroutine below
  # 7) Render outputs to user:
```

| | |
|---|---|
| render_attended_stream(s_hat) | # |

operational output

| | |
|---|---|
| render_explanation_visuals(explanation_struct) | # heatmaps |

/ graphs / AR overlays

| | |
|---|---|
| render_nl_caption(nl_rationale) | # short |

```
textual rationale
  # 8) Log decision and explanation for audit/training
  LOG.append({ time: t,
      P_fused: P_fused,
      attended: s_hat,
      explanation: explanation_struct,
      nl_rationale: nl_rationale })
  # 9) Update reliabilities (online)
```

| | |
|---|---|
| if ground_truth_available( ): | # |

supervised case / occasional feedback
s_star = get_ground_truth( )

| | |
|---|---|
| UPDATE_RELIABILITIES(s_star, s_hat, η) | # see |

```
subroutine below
  else:
    # optional semi-supervised or unsupervised reliability
update rules
    UPDATE_RELIABILITIES_unsupervised(P_fused, {c_i},
observations)
  # 10) Optionally adapt θ_dec or other thresholds based on
context/profile
  θ_dec = ADAPT_THRESHOLD (θ_dec, context_features, r_s,
history = LOG)
end loop
```

Subroutines and Equations

| Subroutine: FUSE (ensemble fusion) | |
|---|---|
| Function FUSE({P_i}, {c_i}): | |
| # Compute normalized confidence-based weights: | |
| total_conf = sum {i=1..N} c_i + ε | |
| for i = 1..N: | |
| w_i = c_i / total_conf | # weight |

```
proportional to confidence
    # Weighted average fusion:
    for each s in S:
        P_fused(s) = sum_{i=1..N} w_i * P_i(s)
    # Optional: sharpen or calibrate fused distribution
(temperature, isotonic calibration)
    P_fused = CALIBRATE(P_fused)
    return P_fused
Equations used:
      w_i = c_i / Σ_{j} c_j + ε
      P\hat{ }{fused}(s) = Σ_{i} w_i P_i(s)
Subroutine: compute_attention_weight (eqn A)
Function compute_attention_weight(P_fused, s):
    # normalized by max fused probability
    max_p = max_{s′} P_fused(s′)
    if max_p == 0: return 0
    α_s = P_fused(s) / max_p
    return α_s
Equation (A): α_s = P\hat{ }{fused}(s) / max_{s′} P\hat{ }{fused}(s′)
Subroutine: compute_utility (eqn B) - learned model placeholder
Function compute_utility(s, observations):
    # Example parametric form or ML model:
    # u_s = w_sem * semantic_score(s) + w_role *
speaker_role_score(s) + w_user * user_pref_score(s) + w_time *
recency_score(s)
    u_s = UtilityModel.predict(features_for_s)
    return u_s
Equation (B) (conceptual):
u_s = f(semantic relevance, speaker role, user preference,
temporal recency)
where f(·) is trained.
Subroutine: compute_cross_modal_consistency (eqn C)
Function compute_cross_modal_consistency(s, observations):
    # Suppose K modalities each produce a modal-hypothesis
\hat{s}_m
    modal_votes = 0
    for each modality m in modalities:
        s_hat_m = modality_attention(m, observations)
        if s_hat_m == s:
          modal_votes += 1
    κ_s = modal_votes / K
    return κ_s
Equation (C): κ_s = (1/K) Σ_{m=1}\hat{ }K I(\hat{s}_m = s)
Subroutine: generate_nl_rationale (template-based)
Function generate_nl_rationale(s, p_s, r_s_hat, δ_s, κ_s):
    # Choose concise template based on dominant explanation
features
    if δ_s >= δ_high and κ_s >= κ_high and r_s_hat >= r_high:
        template = ″Attending to {s} (prob={p:.2f}) because high
reliability ({r:.2f}) and strong cross-modal agreement
({k:.2f}).″
    elif u_s >= u_high:
        template = ″Attending to {s} due to high contextual
importance (u={u:.2f}).″
    else:
        template = ″Attending to {s} (prob={p:.2f}) with margin
{δ:.2f}.″
    # Fill template
    nl = template.format(s = s, p = p_s, r = r_s hat, k = κ_s, u
= u_s, δ = δ_s)
    # Optionally shorten/naturalize via small language model or
grammar rules
    nl = post_process(nl)
    return nl
Examples of text produced:
  □ “Attending to Speaker B (prob=0.74) because reliability=0.88 and
      cross-modal agreement κ=0.92.”
  □ “Attending to Speaker A due to high contextual importance (u=0.86).”
Subroutine: UPDATE_RELIABILITIES (supervised) - reliability eqn
Function UPDATE_RELIABILITIES(s_star, s_hat, η):
    for each s in S:
        indicator = 1 if s == s_star else 0
        r_s = (1 − η) * r_s + η * indicator
    # Optionally normalize or bound r_s to [0,1]
    return
Equation: r_s(t+1) = (1− η) · r_s(t) + η · I(\hat{s} (t) = s*(t))
Subroutine: UPDATE_RELIABILITIES_unsupervised (heuristics)
Function UPDATE_RELIABILITIES_unsupervised(P_fused, {c_i},
observations):
    # Example heuristic: increase r_s when multiple high-
confidence estimators agree
    for s in S:
        agreement = count_estimators_with_top_s(s) / N
        r_s = (1 − η_unsup) * r_s + η_unsup * agreement
    return
(Various unsupervised policies can be implemented; patent covers dynamic
trust update family)
Subroutine: ADAPT_THRESHOLD (optional)
Function ADAPT_THRESHOLD(θ_dec, context_features, r_s, history):
    # Example: reduce threshold if many sources have low
reliability, or raise if noise high
    noise_level = context_features.noise
    avg_reliability = mean_s r_s
    θ_new = θ_dec_base + γ1 * (1 − avg_reliability) + γ2 *
noise_level
    θ_new = clip(θ_new, θ_min, θ_max)
    return θ_new
Subroutine: build_structured_explanation
Function build_structured_explanation(S, P_fused, {α_s}, {r_s},
{u_s}, {δ_s}, {κ_s}):
    heatmap = { (listener, speaker): P_fused(speaker) for each
listener } # or attention matrix
    ranked_sources = SORT_BY(P_fused(s), descending)
    conversation_graph_fragment = build_graph_fragment(S,
edges_weighted_by = (α_s * r_s)
    scores_table = [ (s, P_fused(s), α_s, r_s, u_s, δ_s, κ_s)
for s ∈ S ]
    return {heatmap, ranked_sources,
conversation_graph_fragment, scores_table}
```

Remarks and Implementation Notes

Many internal functions (UtilityModel.predict, attention_estimator_i,
modality_attention, post_process) are learned components - patent
protects the combination and mathematical features, not a single ML
architecture.
Explainability must be concise in real-time: large rationales may be
logged rather than presented.
The system supports augmented reality / virtual reality overlays by
mapping build_structured_explanation elements into UI primitives
(highlight, fade, caption).
Logging LOG enables offline audits, user feedback, and supervised
reliability updates.
Conflict resolution or external sampling (if P\hat{ }{fused}(s_hat) <
θ_{dec}) may invoke additional modules - explainability module still
computes features for transparency.

What is claimed is:

1. A system for explainable selective attention in multi-source environments, comprising:
a plurality of probabilistic attention estimators, each generating a distribution over a set of sources and an associated confidence score;
a fuser combining the distributions into a fused belief distribution;
an explainer deriving explanation features comprising at least one of:
attention weights,
reliability scores,
utility scores, and
decision threshold margins; and
an interpreter generating structured outputs or natural language rationales based on the explanation features.

2. The system of claim 1, wherein the structured outputs comprise visual heatmaps highlighting relative attention weights across sources.

3. The system of claim 1, wherein the structured outputs comprise conversation graphs with nodes representing sources and edges weighted by attention strength.

4. The system of claim 1, wherein said interpreter generates natural language justifications, comprising at least one sentence explaining why a source was attended to.

5. The system of claim 1, wherein the reliability scores are updated dynamically based on at least one of historical accuracy, latency performance, and consistency across modalities.

6. The system of claim 1, wherein the utility scores are computed as a function of contextual relevance and user preferences.

7. The system of claim 1, wherein said interpreter renders rationales in augmented reality or virtual reality environments, including overlays aligned with attended sources.

8. The system of claim 1, wherein said explainer produces confidence margins by computing differences between decision thresholds and fused probabilities.

9. The system of claim 1, wherein the explanations are logged for auditing, regulatory compliance, or post-hoc analysis.

10. The system of claim 1, wherein the explanation features further comprise cross-modal alignment scores indicating consistency between modalities such as audio, video, and physiological signals.

11. A method of explainable selective attention, comprising:
receiving multimodal signals from a plurality of sources;
generating source-specific probability distributions and confidence scores using probabilistic attention estimators;
fusing the probability distributions into a fused belief distribution;
computing explanation features comprising at least attention weights, reliability scores, or decision margins; and
generating interpretable rationales in structured or natural language form.

12. The method of claim 11, further comprising rendering a visual heatmap of attended sources.

13. The method of claim 11, further comprising generating a conversation graph representing attention dynamics among multiple speakers.

14. The method of claim 11, wherein the interpretable rationales are expressed as natural language statements generated from explanation features.

15. The method of claim 11, further comprising dynamically updating trust or reliability scores for each source.

16. The method of claim 11, wherein the structured rationale is presented in real-time within an augmented reality/virtual reality interface.

17. The method of claim 11, further comprising logging the explanation features and rationales to a knowledge base for retrospective analysis.

18. The method of claim 11, wherein explanation features further comprise user-specific utility values that adjust importance of certain sources.

19. A non-transitory computer-readable medium storing instructions that, when executed by a processor, cause the processor to perform a method comprising:
receiving multimodal inputs from a plurality of sources;
computing probabilistic attention distributions and confidence scores;
fusing the distributions into a fused belief distribution;
computing explanation features including attention weights, reliability scores, or threshold margins; and
outputting structured or natural language rationales for the selective attention decision.

20. The non-transitory computer-readable medium of claim 19, wherein the structured rationale comprises visual attention overlays.

21. The non-transitory computer-readable medium of claim 19, wherein the natural language rationale comprises explanations of source prioritization expressed in a shared vocabulary.

22. The non-transitory computer-readable medium of claim 19, wherein the instructions cause the processor to log explanations and features for compliance in regulated environments.

23. The non-transitory computer-readable medium of claim 19, wherein the instructions cause the processor to generate conversation graphs with weighted edges representing inter-speaker relationships.

24. The non-transitory computer-readable medium of claim 19, wherein the instructions cause the processor to compute explanation features including cross-modal consistency metrics between modalities.
